(19) United States
(12) Patent Application Publication
(10) Pub. No.: US 2007/0108755 A1
(43) Pub. Date: May 17, 2007

(54) Apparatus for generating haptic signals

(76) Inventor: Mark De Cooper Jones, Redditch (GB)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/594,008

(22) Filed: Nov. 7, 2006

(30) Foreign Application Priority Data
Nov. 8, 2005 (GB) GB 0522751.7

(51) Int. Cl. B60R 22/00; B60K 28/00; H04B 3/36

(52) U.S. Cl. 280/801.1; 180/271; 340/407.1; 297/483

(57) ABSTRACT

An apparatus for generating haptic signals is disclosed which is adapted to be fitted to a seatbelt of a vehicle and which is adapted to vibrate when a signal is received from a control unit such that the vibration can be felt by a driver of the vehicle wearing the seatbelt. It can serve in the method of reducing discomfort to a person travelling by vibrating their seatbelt.

### CROSS-REFERENCE TO RELATED APPLICATIONS

This application claims priority to Great Britain Patent Application No. 0522751.7 filed Nov. 8, 2005, the disclosures of which are incorporated herein by reference.

### BACKGROUND OF THE INVENTION

This invention relates to improvements in apparatus for providing haptic information to a person. It in particular has application in providing haptic warnings or signals to a driver of a vehicle, although it may find other application.

It is known that drowsiness of a driver or other inattention is a major cause of accidents. It is unfortunately most common on high speed, multiple lane highways used by drivers travelling long distances. A moment's inattention may be enough for the driver to allow the car to drift out of a lane and off the highway or into another vehicle.

Various attempts have been made to help maintain the drivers attention and in particular to help the driver stay awake. Lane guidance systems have been developed which enable a car to identify where it is on a highway and when a vehicle is leaving or about to drift out of a lane. These typically rely on information from a camera fitted to the front of the vehicle to identify lane markings.

It is also known to provide various warnings to a driver that the vehicle is about to drift out of a lane based on the information provided from the lane guidance (or other control) system. In its simplest form, this may comprise an audible alarm. Such alarms are effective but are not suitable for people with impaired hearing.

One alternative is to provide a haptic signal or warning to a driver as part of a driver assistance system (DAS). Haptic devices are devices that generate and control haptic sensations through information flow. It has been proposed to use haptic signals in addition to or instead of audible and visible signals. In one arrangement, it is proposed to vibrate the vehicle steering wheel to simulate the motion of a vehicle passing over a rumble strip at the edge of a road. In another, it has been proposed to provide actuators in the base of the driver's seat and to vibrate the seat by energising the sensors. Such devices are known as lane change assistants and are fitted to a number of models of road going vehicles. In each case, solutions that are built into a seat or steering system are costly, as they need to be high power and have to be engineered into the design of the vehicle at an early stage making them inflexible in versatility of application.

### BRIEF SUMMARY OF THE INVENTION

According to a first aspect, the invention provides an apparatus for generating haptic signals which is adapted to be fitted to a seatbelt of a vehicle and which is adapted to vibrate when a signal is received from a control unit such that the vibration can be felt by a driver of the vehicle wearing the seatbelt.

Providing a device which is adapted to be fitted to a seatbelt and which vibrates to provide haptic signals to a driver has been found to provide a simple, elegant, solution to the problem of passing information to a driver of a vehicle.

By fitted to a seatbelt we may mean a device that is fixed on to the outside of a seatbelt or a device that is fitted within a portion of a seatbelt or a combination of the two. Fitting to the outside is preferred as it ensures the device will not become embedded in the wearer as the belt tightens in the event of an accident.

The device may therefore comprise an integral part of the seatbelt itself. The vibration of the device, or at least a part of it, may cause the seatbelt to vibrate. Indeed, the device itself may not vibrate but may simply cause the seatbelt to which it is fitted to vibrate and this is to be considered to be within the scope of at least one aspect of the invention.

The device may comprise a transducer which is adapted to convert electrical energy of a control signal into mechanical energy such that it can vibrate when driven by a suitable control signal, a housing which surrounds the transducer, a transfer means (i.e. transfer device) which is secured to the item worn by the person which transfers energy from the transducer into the item, and biasing means (i.e. biasing device) which is adapted to bias the transducer into contact with the transfer means.

The transfer means provides an efficient way of passing energy from the transducer into the seatbelt and hence to the driver.

The transfer means may comprise a rigid element or a flexible element, which is secured to the seatbelt. It may be riveted in position by a rivet passing through the seatbelt, or preferably is glued in position. It is preferably bonded to the outside of the seatbelt, e.g. the side facing away from the wearer of the belt.

Most preferably, the transfer means comprises a magnet or a material that is attracted to magnets such as a magneto-steel material.

The transducer may comprise a motor, preferably a multi-phase rotating eccentric disk motor. It may comprise a solenoid. The commonality between these two choices is that they both are capable of providing a high degree of vibrational energy from a small package size.

The biasing means most preferably comprises a magnet to be used in combination with a transfer means that is magnetic or ferromagnetic. The transducer may then be positioned at least partially in between the biasing means and the transfer means such that it is held in position by the magnetic force between the transfer and the biasing means.

An advantage of this arrangement is that the device can be arranged with minimal loss of energy from the transducer into the housing.

Alternatively, the biasing means may be resilient and act between the transducer and the housing to press the transducer onto the transfer means. It may comprise a spring, such as a plastic coil or leaf spring. This will transfer some energy into the housing, and should be designed such that this is minimised.

The housing is preferably arranged to cover the transducer to protect it from damage but to provide minimal or no path for the transfer of energy from the transducer into the housing. It may include a cavity into which the transfer means, transducer and biasing means are fitted substantially without contact. It may include one or more protrusions, preferably a minimum of three protrusions, into the cavity that locate the transducer and/or transfer means radially in the cavity with minimal contact.

The housing means may include a means for attachment to the seatbelt. It may, for example, be provided with two or more shallow spaced arms or cleats that surround the edges of the belt to grip the housing in place.

There may be more than one transducer and each one may have its own transfer means. This has the advantage of minimising the risk of out of phase vibrations cancelling each other out. There may, for example, in a most preferred arrangement be four transducers arranged in a two by two grid. Each may be separately actuable, i.e. can be made to vibrate independent of the others.

Where there are more than one transducer, each may be housed in a separate cavity in the housing. The housing may be flexible to permit the transducers to move relative to one another as the seatbelt is bent. It may be segmented. It may be articulated to permit it to flex in use and permit relative movement of the transducers. This will help the belt to conform to a drivers shape, better to transfer signals to the driver by ensuring close contact over as large an area as possible.

In an alternative, more than one housing could be provided to permit the transducers to be spaced along a seatbelt.

A control means may be provided for generating signals to drive the or each transducer. The signals may be produced which are dependent upon hazard information determined from one or more sensors fitted to a vehicle. For example the control signal may cause or more transducers to vibrate when a vehicle is drifting out of a lane.

The device may vary the number of transducers that vibrate depending on the severity of the warning. For example, different control signals may be provided which cause each transducer to behave in a predefined way. Different patterns and sequences of vibration can be used depending on the application. For example with the transducers could be connected in pairs.

In a simple arrangement, all transducers may be vibrated at a low magnitude if a vehicle drifts towards a lane boundary, and vibrated more as the vehicle gets nearer to leaving or leaves the lane.

Alternatively, more transducers may be vibrated as the vehicle gets nearer to leaving a lane (or at some other hazard).

In another, alternative transducers at different locations in the housing may be vibrated to give some additional meaning to the haptic signal. Transducers towards the left side of the housing (from the wearers viewpoint looking towards the front of the vehicle) could be made to vibrate whilst the others are still (or vibrating less) to indicate a hazard towards the left. This could indicate that the vehicle is drifting left or that a hazard is approaching from the left. The opposite could be applied to indicate hazards to the right or drifting right by vibrating the ones on the right more. They could even all be vibrated at once, or just transducers towards the centre where provided to indicate a hazard straight ahead. Thus, the control means may also vary the intensity of vibration (its magnitude) and or the frequency to provide difference signals and/or the number vibrated at any time or the sequence in which they vibrate.

The control means may comprise a signal processor. It may be provided at least partially within the device housing or may be fitted elsewhere on the vehicle and connected to the device.

The device may be connected wirelessly to a control unit that comprises a processor on the vehicle. It may be connected using a radio frequency link. It may be self-powered, and include one or more batteries such as Ni—Cd type batteries. It may include a receiver, a processing circuit, which interprets signals received by the receiver, and a driver circuit, which acts upon the signals received to drive one or more transducers causing them to vibrate.

The receiver may comprise a radio frequency (RF) receiver, which may be adapted to receive signals from a transmitter fitted to the vehicle. This transmitter may in turn be driven by a control circuit that forms part of a vehicles hazard warning system.

In a preferred arrangement, the receiver, processing circuit and driver circuit may be mounted to a single pcb (printed circuit board), which may be flexible. The processing circuit may include a microprocessor with memory containing program instructions. An inductive loop may also be provided for charging the battery through inductive coupling to a power source located on the vehicle.

The device is preferably arranged such that it is substantially on the face of the seatbelt that faces away from the driver. This ensures that in the event of an accident causing the driver to be pushed into the belt the device is not pushed into the driver's skin.

By this, we may mean that no active parts of the device are on the side of belt facing the driver. This may include the transducer (or transducers), the transfer means and the biasing means and most, if not all of the housing.

The transfer means may therefore be glued to the outward facing side of the seatbelt.

The device may be fitted to a seatbelt in proximity to a lower end of the belt whereby in use the device will be positioned in contact with a stomach or lap region of a driver. It may include a means for attachment to a rivet eye at the end of a stopper bar for the seatbelt.

One or more wires may connect the device to a processor fitted to the vehicle. The or each wire may be fastened to the seatbelt. They may, in a most preferred arrangement be stitched in position on the seatbelt, along an edge for example.

According to a second aspect the invention provides apparatus adapted to be fitted to an item worn by a person comprising:

a transducer which is adapted to convert electrical energy of a control signal into mechanical energy such that it can vibrate when driven by a suitable control signal;

a housing, which surrounds the transducer;

transfer means which is secured to the item worn by the person which transfers energy from the transducer into the item, and

biasing means, which is adapted to bias the transducer into contact with the transfer, means the device being arranged such that when a signal is applied to the apparatus it vibrates such as to provide a haptic signal to the wearer of the item.

The item may comprise a seatbelt. Alternatively, it may comprise an item of clothing.

The device may be adapted to provide haptic signals to the wearer, which assist the wearer in driving the vehicle.

The device may alternatively or additionally be fitted to a seatbelt and be adapted to provide haptic signals that have a therapeutic effect on the wearer so as to reduce the effects of travel sickness.

The device may reduce these effects by applying haptic signals which distract the wearer and this has been found to reduce the incidence of travel sickness in many people, and in particular in young children and infants.

According to a third aspect, the invention provides a retro-fittable device which includes means for securing itself to an item worn by a user, the device being in accordance with the second aspect of the invention.

According to a fourth aspect, the invention provides a method of providing haptic information to a driver of a vehicle, the method comprising providing a device which is fitted to a seatbelt and applying one or more control signals to the device so as to cause the device, in use, to vibrate at least a part of the seatbelt.

According to a fifth aspect, the invention provides a method of reducing discomfort to a person travelling in a vehicle comprising vibrating a seatbelt worn by the person.

The method may be performed using a device according to one of the preceding aspects of the invention.

It has been shown that vibrations applied to a person in a vehicle can prove effective in reducing discomfort such as that associated with the feeling of travel sickness.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is an isometric view from above and to one side of a device in accordance with a first aspect of the invention fitted to a seatbelt;

FIG. 2 is a cut-away view of the device of FIG. 1 showing a cross section through the device;

FIG. 3 is an isometric from above and to one side of the device of FIG. 1 with the cover removed;

FIG. 4 is a cross sectional view of the device showing the location of the steel disks fixed to the seatbelt and the actuators;

FIG. 5 is an enlarged part cross section showing in detail the location of the actuator and magnet in one section of the housing;

FIG. 6 is an isometric view from below and to one side of the device fitted to a seatbelt;

FIG. 7 shows the device incorporated into a vehicle system for providing haptic signals to a person wearing a seatbelt;

FIG. 8 shows an alternative partial schematic view of an alternative embodiment of a device according to the first aspect of the invention; and

FIG. 9 is a partial isometric view from above and to one side of a device that incorporates a spring in accordance with the principles of FIG. 8.

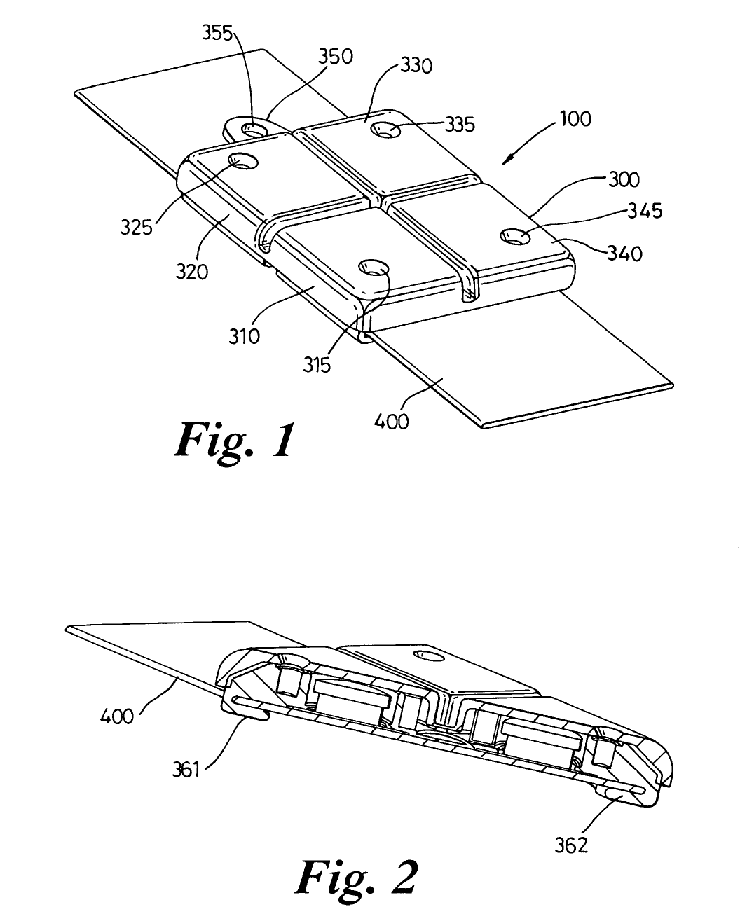

### DETAILED DESCRIPTION OF THE INVENTION

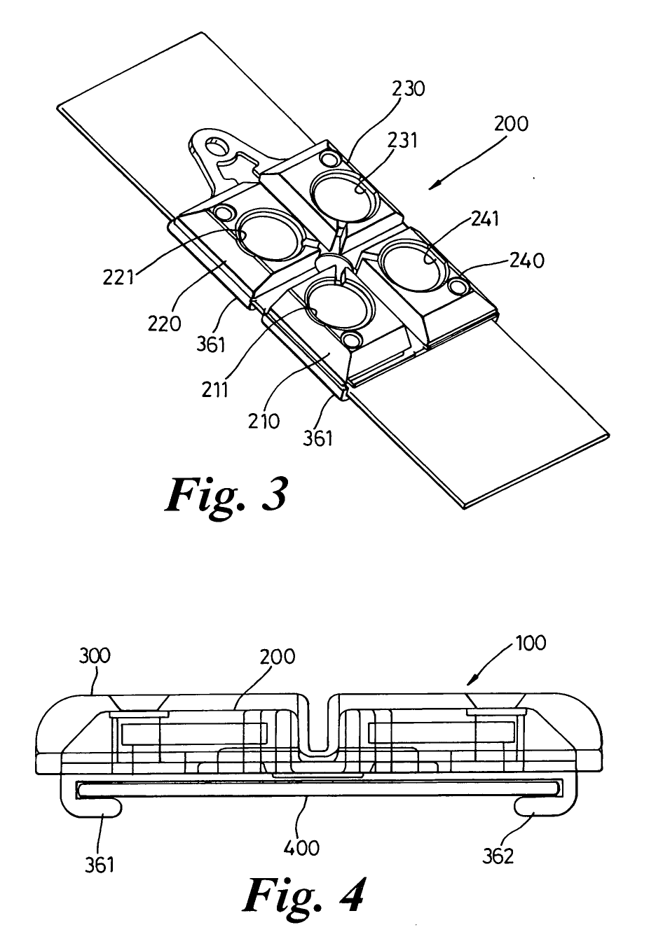

The device 100 comprises a thin, generally rectangular, housing 200 (shown best in FIG. 3) and a complementary cover 300 that clips over it. The cover is divided into four sections 310, 320, 330, and 340. The cover 300 also has a tab 350 extending from one end which includes a hole 355 for receiving a rivet (not shown) that attaches it to a portion of seatbelt 400. The cover 300 is a snap fit onto the housing 200 and can also be secured by four screws that each pass through a respective countersunk opening 315, 325, 335, and 345 in each of the cover sections. Soft foam spacers (not shown) between the housing and the cover help isolate the cover from the housing against vibrations.

Each of the four sections of the cover 300 correspond with one of four sections 210, 220, 230, and 240 of the housing 200. These sections are arranged in a grid. Each section of housing comprises a cylindrical opening 21, 221, 231, and 241 that passes completely through the housing to allow access to a portion of the seatbelt 400 through the opening. The cover 300 fits over the housing 200 so as to cover the openings and, as will become apparent, ensure retention of various components within each opening. The housing 200 has four thin arm portions 361, 362 arranged in pairs that clip the housing around a portion of a seat belt webbing. This can best be seen in FIG. 4, where the pairs of arms and underside of the housing form a C-shape which receives the seatbelt

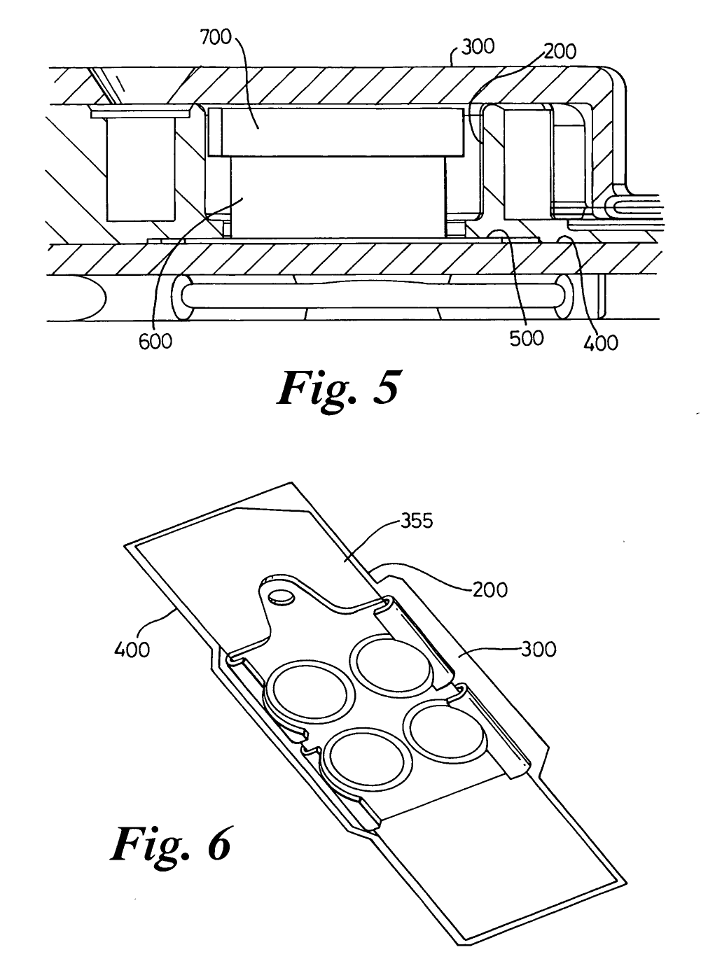

As best seen in FIG. 5, each opening contains an assembly comprising a transfer means 500, a transducer 600 and a biasing means 700. The transfer means comprises a magneto-steel disk of about 12 mm diameter that is glued to the seatbelt. Two such assemblies can be seen in the cross section of FIG. 4, although since four openings are provided it will be appreciated that there are four disks glued in a 2 by 2 grid. The centre of each steel disk 500 is chosen to coincide with the centre of its respective opening in the housing 200.

Above the disk 500 within the opening is a cylindrical transducer 600. This is also in the shape of a disk of about 12 mm diameter and 3.5 mm thickness. A pair of wires (not shown) lead from the transducer 600 through an outlet in the housing 200, which opens in to the opening. The wires from each of the four transducers pass out of the housing 200 and are stitched along the side of the seatbelt.

Above the transducer 600 is a biasing means 700, which comprises a magnet. This is also shown as a disk but could be of a different shape. The magnet 700 is attracted to the metal disk 500 and so clamps the transducer 600 in place. This arrangement ensures that energy from the transducer is coupled into the disk and therefore into the seatbelt.

The height of the disk is chosen such that when the cover is in place there is room for the transducer and the biasing means in a stack without the biasing means touching the inside of the cover 300. This ensures that the amount of energy transfer to the cover is minimal.

Additionally the diameter of the opening is greater than that of any of the components it contains. Three small inwardly extending tangs (not shown) are provided which help to centralise the metal disk 500 in the opening, and these also minimise energy transfer to the housing whilst helping located the housing and hence cover in position. No other form of fixing to the seatbelt 400 is therefore needed once assembled, other than the use of a rivet to locate the housing (although this is optional).

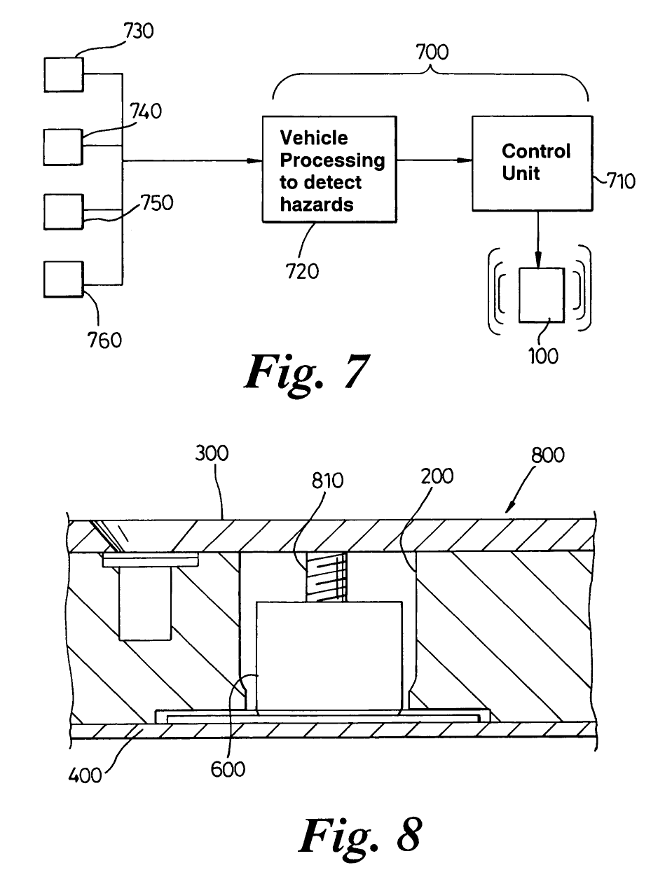

In use, each of the wires from the transducers of the device 100 is connected to an output port of a vehicle control system as shown in FIG. 7. This can be achieved by connecting a connector that forms part of the vehicles wiring loom to a control unit 710 which receives signals from a vehicle processing unit 720 such as used for determining vehicle position in a lane. The processing unit derives signals from various sensors including a radar unit 730, a speed unit 740, a yaw sensor 750 and a steering position sensor 760. Of course, other combinations of sensor could be used as well as other types of sensors. A voltage is applied to one or more of the wires to cause the transducer connected to that wire to vibrate. The control unit 710 is configured to apply a different voltage to one or more of the transducers to either cause them all to vibrate at the same time, in a sequence or in sets such as in pairs. This allows different messages to be signalled to the wearer of the belt.

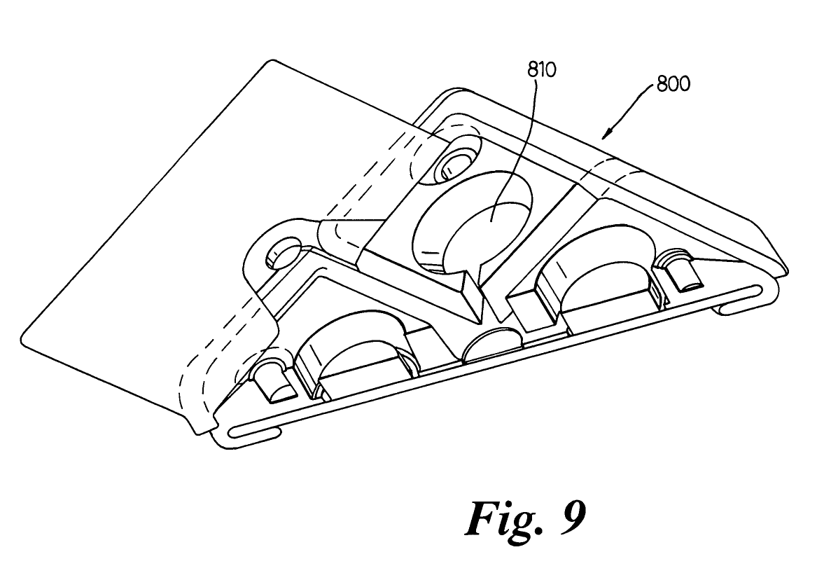

Various modifications are possible. In one alternative embodiment 800 shown in FIGS. 8 and 9 a spring 810 is used in place of the magnet. Otherwise, the parts of the device are substantially the same and are marked with the same reference numerals as for the first embodiment for clarity. The spring 810 acts between the cover and the top of the transducer.

In another arrangement, not shown, the housing may also contain a control unit, a source of electrical power such as a battery and an RF receiver. The vehicle is also fitted with an RF transmitter. When a haptic signal is required, the vehicle transmits a signal at a strength and frequency that can be detected by the RF receiver. On receiving the signal, the control unit generates the required signal to apply to one or more of the transducers to cause them to vibrate. If required the transmitted signal could contain information about the type of haptic signal required, e.g. vibrate all transducers, vibrate one, etc.

The device can be used to provide a haptic warning signal to a driver in the event that a crash may occur, such as when a vehicle is drifting out of a lane.

It may also be used as a device for alleviating discomfort to a person travelling in a vehicle. It is known that many people, especially children, suffer from motion sickness (sometimes called travel sickness) which is somewhat discomforting. Vibrating the person's seatbelt whilst the vehicle is in motion may help to reduce this discomfort and tests have shown that providing haptic stimulae to persons during travel can help make them more comfortable.

1. An apparatus for generating haptic signals which is adapted to be fitted to a seatbelt of a vehicle and which is adapted to vibrate when a signal is received from a control unit such that said vibration can be felt by a driver of said vehicle wearing said seatbelt.

2. An apparatus according to claim 1, which comprises an integral part of said seatbelt and is adapted to cause said seatbelt to vibrate.

3. Apparatus according to claim 1 which comprises a transducer which is adapted to convert electrical energy of said signal from said control unit into mechanical energy, a housing which surrounds said transducer, a transfer device which is secured to said seatbelt which transfers energy from said transducer into said seatbelt, and biasing device which is adapted to bias said transducer into contact with said transfer device.

4. Apparatus according to claim 3 wherein said transfer device comprises a rigid element which is secured to said seatbelt.

5. Apparatus according to claim 3 wherein said transfer device comprises at least one of a magnetic material and a magnetically susceptive material.

6. Apparatus according to claim 3 wherein said transducer comprises a motor.

7. Apparatus according to claim 6 wherein said motor comprises a multi-phase rotating eccentric disk motor.

8. Apparatus according to claim 3 wherein said biasing device comprises a magnet to be used in combination with a transfer device that is one of at least magnetic and ferromagnetic.

9. Apparatus according to claim 8 wherein said transducer is positioned at least partially in between said biasing device and said transfer device such that it is held in position by a magnetic force between said transfer and said biasing device.

10. Apparatus according to claim 3 wherein said biasing device is resilient and acts between said transducer and said housing to press said transducer onto said transfer device.

11. Apparatus according to claim 10 wherein said biasing device comprises a spring.

12. Apparatus according to claim 3 housing is arranged to cover said transducer to protect it from damage but to provide a minimal path for said transfer of energy from the transducer into said housing.

13. Apparatus according to claim 12 wherein said housing includes a cavity into which said transfer device, transducer and biasing device are fitted.

14. Apparatus according to claim 3 wherein a control device is provided for generating signals to drive said transducer.

15. Apparatus according to claim 13 where more than one transducer is provided and wherein said control device varies a number of transducers that vibrate depending on a severity of said warning.

16. Apparatus adapted to be fitted to an item worn by a person comprising: a transducer which is adapted to convert electrical energy of a control signal into mechanical energy such that it can vibrate when driven by a suitable control signal;
a housing, which surrounds said transducer;
transfer device which is secured to said item which transfers energy from the transducer into said item, and
biasing device, which is adapted to bias, said transducer into contact with said transfer device, said device being arranged such that when a signal is applied to said transducer it vibrates such as to provide a haptic signal to said wearer of said item.

17. Apparatus of claim 16 in wherein said item comprises a seatbelt.

18. A method of providing haptic information to a driver of a vehicle, said method comprising providing a device that is fitted to a seatbelt and applying at least one control signal to said device so as to cause said device, in use, to vibrate at least a part of said seatbelt.

19. A method of reducing discomfort to a person travelling in a vehicle comprising vibrating a seatbelt worn by said person.
